(19) United States
(12) Patent Application Publication
(10) Pub. No.: US 2016/0300294 A1
(43) Pub. Date: Oct. 13, 2016

(54) Methods, Systems and Apparatus for Gifting Collectively

(71) Applicant: HORTON RIVER HOLDINGS PTY LTD, Tamworth (AU)

(72) Inventor: Charles Howard ROCHE, Barraba (AU)

(73) Assignee: HORTON RIVER HOLDINGS PTY LTD, Tamworth, (AU)

(21) Appl. No.: 15/038,568

(22) PCT Filed: Nov. 21, 2014
(86) PCT No.: PCT/AU2014/050366

§ 371 Date: May 23, 2016

(30) Foreign Application Priority Data
Nov. 22, 2013 (AU) 2013904521

(51) Int. Cl. G06Q 30/06; G06F 3/0481; G06F 3/0484; H04L 12/58; G06F 3/0482

(52) U.S. Cl. CPC G06Q 30/0643; H04L 51/32; G06F 3/0482; G06F 3/04842; G06F 3/04845; G06F 3/04817

(57) ABSTRACT

A method, system and apparatus for gifting collectively. A gift giver for a gift occasion or significant event may initially arise from an initial guest list and/or an initial pool of potential gift givers. Then as a collective gift giving progresses a feedback pool of gift givers may dominate as the source of the gift givers for the collective gift. The operation of a feedback loop as shown may serve to efficiently and rapidly progress the collective gift to purchase completion. The gain of the feedback loop may be controlled or varied in a variety of ways. Gift portions may be in the form of a segmented overlay, a symbolic overlay with symbolic segments corresponding to components of the gift and other forms as described herein.

### BACKGROUND OF THE INVENTION

1. Field of the Invention

The present invention relates to a collective gifting platform, a system or a method for a group of gift givers to act collectively in purchasing a gift for a significant event or a stated aim. The invention is particularly for interactive use online, via the internet or mobile telecommunication services.

2. Description of the Art

Gift registries, in particular for weddings, are an established service offering found globally. A gift registry is now used more generally for occasions such as baby showers, engagements and birthdays. The purpose of a gift registry has traditionally been so that gift recipient/s can communicate to their guests what it is they may want by way of a gift or gifts, and to provide an element of insurance or control that they will not receive unwanted or duplicate gifts. However, business competition tends to result in gift registries being limited to a single store with a limited catalogue of products from a limited range of brands, manufacturers or service providers. Further, items offered by a particular store typically focus on small appliances and household items which may include, for example, an electric toaster, an electric kettle, cookware, glassware, dining settings, sheets, towels and general household linen. The purpose of establishing a gift registry of such items has traditionally been to help a couple “set up” their home.

In addition however, small appliances and household items serve the interests of the store in that these items are often at a level of monetary expense that an individual guest or couple may feel comfortable in paying. That is, from a list of available gifts on a registry, an individual guest or a couple may select a gift at a cost that is aligned to their desires as to what is an appropriate amount of money to spend for a single gift item. In addition the store providing the gift registry service only has to deal with a single customer for each gift purchased at the store. These limitations serve only to reduce flexibility and limit the choice of available products when gift recipient/s is choosing their gifts.

The advent of cheap manufacturing imports, rising affluence, mass marketing and ease of access to online and offline purchasing channels has resulted in making small appliances and household items more affordable and more easily accessible than at any other time in history. Furthermore, with increasing pressure on housing availability, relaxing attitudes towards cultural and/or religious practices and the rising cost of housing, more and more couples are choosing to live together before they marry. As a result of these changing social, cultural and economic trends, many couples are choosing to co-habit prior to getting married so that accordingly, they already own many of the small appliances and household items traditionally given as gifts at a wedding.

The increasing trend of co-habitation among couples prior to being married has brought only a small change to the traditional custom of giving small appliances and household items as gifts at weddings. An aspect of gift giving that has experienced change in response to the trend of couples already living together however, can be seen in an increased demand for “wishing-well” or “contribution-style” gift registries. A “wishing-well” or “contribution-style” gift registry, either physically or online, operates as a ‘donation box’ into which guests may contribute a monetary donation for the gift recipient/s. For example at a wedding, a bride and groom may establish a wishing well to ask their friends and loved ones to donate money into it instead of purchasing individual gifts. The reasons for establishing a wishing well may include, for example, to help the gift recipient/s acquire a more expensive item (e.g. an artwork or piece of furniture), an experience or a service (e.g. luxury honeymoon) or to collect money to form a deposit for purchasing a house or even to donate the money that would otherwise be spent on gifts, to a charitable cause.

However, wishing-well type registries lack a personal connection between the giver and receiver, and bring with them a feeling of awkwardness and lack of appropriate ceremony as a result of simply handing over cash or a cheque rather than a physical object or a service that is associated with the gift giver.

None of these prior art methods, systems and apparatus provides an entirely satisfactory solution to the provision of a gift, as nominated by a gift provider or gift receiver/recipient, by multiple gift givers.

Any reference herein to known prior art does not, unless the contrary indication appears, constitute an admission that such prior art is commonly known by those skilled in the art to which the invention relates, at the priority date of this application.

### SUMMARY OF THE INVENTION

The present invention aims to provide an alternative collective gifting platform, system or method which overcomes or ameliorates the disadvantages of the prior art, or at least provides a useful choice.

In one form, the invention provides a method for gifting collectively comprising the steps of: providing a gift for a significant event, dividing the gift into at least two gift portions, notifying at least two gift givers to the significant event, each gift giver selects one or more gift portions associated with the significant event, purchasing of each selected gift portion by each selecting gift giver, repeating the previous two steps until substantially all the gift portions are purchased, and providing the gift to a gift recipient, thereby the gift givers collectively gift to the gift recipient.

The method further including the step of: communicating to a pool of gift givers the purchase of each selected gift portion.

The method further including the step of: varying a feedback loop gain by varying at least one of a social media sharing or interaction, a number of repeat purchases of gift portions by each gift giver and the time between each gift portion purchased.

The method further including the step of: communicating to the pool of gift givers of the purchase of gift portions prior to the purchase of all the gift portions.

The method further including the steps of: representing the gift as a gift image, and dividing the gift image into the gift portions.

The method further including the step of: displaying or indicating the purchased gift portions with or on the gift image.

The method further including the step of: assigning at least one gift portion to at least one component of the gift represented by the gift image.

The step of dividing the gift into gift portions includes creating at least one symbolic gift portion and assigning the symbolic gift portion to the corresponding component of the gift represented by the gift image.

In a further form, the invention provides a method of collectively revealing a gift image including the steps of: providing a gift image; creating a selectively removable overlay, the overlay having at least two selectively removable segments, each segment being superimposed on a portion of the gift image; providing a pool of gift givers; and enabling at least one gift giver to selectively remove one or more of the selectively removable segments of the overlay; whereby the gift image is progressively revealed.

The method further including the step of: assigning each segment a monetary value.

The method further including the step of: enabling the at least one gift giver to participate in selectively removing the segment upon payment of the monetary value for the segment.

The method further including the step of: selectively removing segments and displaying the gift image with a graphical user interface.

The method further including the step of: assigning at least one segment to at least one corresponding component of a gift represented by the gift image.

The step of creating the overlay includes creating a symbolic overlay and assigning at least one symbolic segment to a corresponding component of a gift represented by the gift image.

The method further including the step of: communicating to the pool of gift givers the selective removal of a segment.

In an alternate form, the invention provides a graphical user interface for a gift collective system comprising: a gift dividing means for use by at least one of a gift provider and a gift recipient to divide a gift into two or more gift portions; a means for displaying the gift portions to at least two gift givers; a selecting means for one or more gift portions by each gift giver, a means for indicating selected gift portions; and a processor, wherein the processor is configured to provide at least one of: the gift dividing means, the means for displaying, the selecting means and the means for indicating.

The gift dividing means includes a pattern overlay to a gift image of the gift and the pattern overlay delineates the gift portions.

The gift dividing means includes a means for selecting components of the gift to form the gift portions.

In yet another alternate form, the invention provides a gift collective system comprising: an interface means for a gift recipient or a gift provider to select a gift, a gift dividing means for dividing the gift into at least two gift portions, a graphical user interface means displaying the gift portions to at least two gift givers, a processor, and a memory means for registering a status of the gift portions, wherein the processor is configured to perform at least one of: the interface means and the gift dividing means; wherein the graphical user interface means interacts with each gift giver so that each gift giver can select and purchase at least one gift portion and the graphical user interface means interacts with the memory means to the status of a purchased gift portion; and whereby a purchase of substantially all of the gift portions by the gift givers provides the gift to the gift recipient.

The gift collective system further including a means for representing the gift as a gift image and the gift dividing means dividing the gift image into the gift portions.

The gift collective system further including the processor being also configured to perform at least one of: the graphical user interface means and a monitoring means for a total of the purchased gift portions.

The gift collective system further including the processor being configured to communicate one or more gift portions statuses to a group of gift givers.

In yet another form, the invention provides a method for gifting collectively substantially as described herein with respect to the figures.

In another form, the invention provides a graphical user interface substantially as described herein with respect to the figures.

In another form, the invention provides a gift collective system substantially as described herein with respect to the figures.

Further forms of the invention are as set out in the appended claims and as apparent from the description.

### Disclosure of the Invention

### BRIEF DESCRIPTION OF THE DRAWINGS

The description is made with reference to the accompanying drawings, of which:

FIG. 1: Illustrates a system process overview for a Gift Receiver as a flowchart or flow diagram;

FIG. 2: Illustrates the Gift Receiver's Primary Account Page;

FIG. 3: Illustrates the system process overview for Gift Giver;

FIG. 4: Illustrates the steps relating to registration for a new Gift Receiver/recipient;

FIG. 5: Illustrates the steps relating to a returning Gift Receiver to undergo a login process;

FIG. 6: Illustrates the steps relating to a Gift Receiver creating a Gift Occasion/significant event;

FIG. 7: Illustrates the steps relating to a Gift Receiver sharing a gift portion electronically;

FIG. 8: Illustrates the steps relating to a Gift Receiver collecting their balance;

FIG. 9: Illustrates the steps relating to a Gift Giver conducting a selection and purchase of a gift portion;

FIG. 10: Illustrates the steps relating to a Gift Giver sharing a gift portion electronically;

FIG. 11: Illustrates a sample puzzle overlay, which hides a Gift Receiver's gift image beneath:

FIG. 12: Illustrates a sample pyramid overlay, which hides a Gift Receiver's gift image beneath;

FIG. 13: Illustrates a sample brick overlay, which hides a Gift Receiver's gift image beneath;

FIG. 14: Illustrates a sample chain link overlay, which hides a Gift Receiver's gift image beneath;

FIG. 15: Illustrates a sample mosaic overlay, which hides a Gift Receiver's gift image beneath;

FIG. 16: Illustrates a sample paving overlay, which hides a Gift Receiver's gift image beneath;

FIG. 17: Illustrates a sample ladder overlay, which hides a Gift Receiver's gift image beneath;

FIG. 18: Illustrates a sample step or stair overlay, which hides a Gift Receiver's gift image beneath;

FIG. 19: Illustrates a sample pushbike image, which a Gift Receiver may break up or nominate into individual components (e.g. handlebars, seat, wheels, etc.);

FIG. 20: Illustrates a sample car image, which a Gift Receiver may break up or nominate into individual components (e.g. wheels, spoiler, car door, windscreen, etc.); and

FIG. 21: Illustrates another example of the invention with respect to a wine rack or “Cellar Party” collective gift.

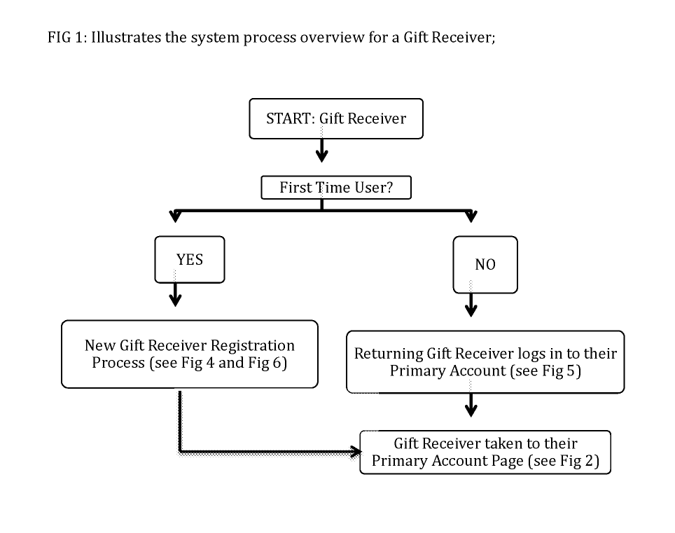

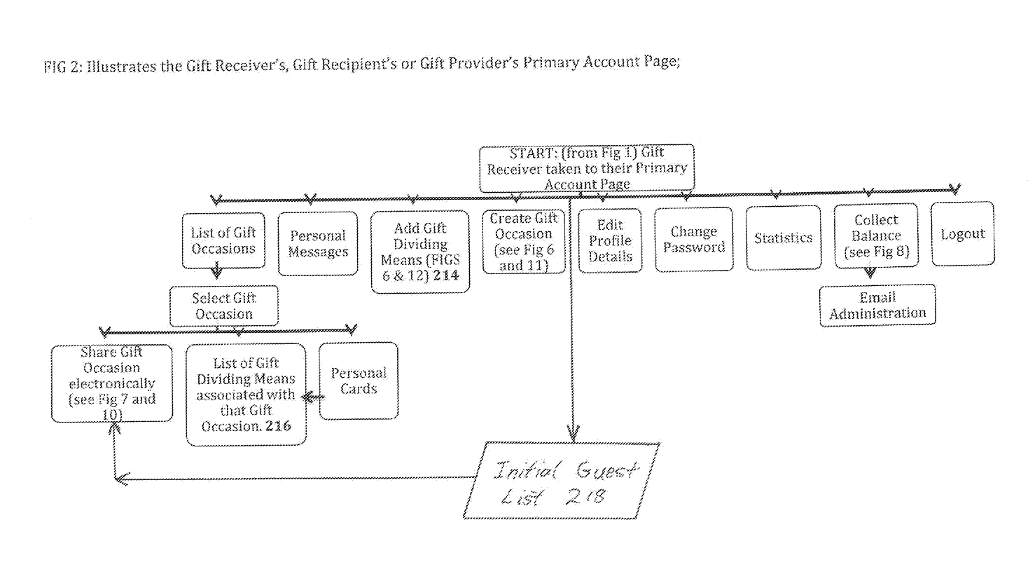

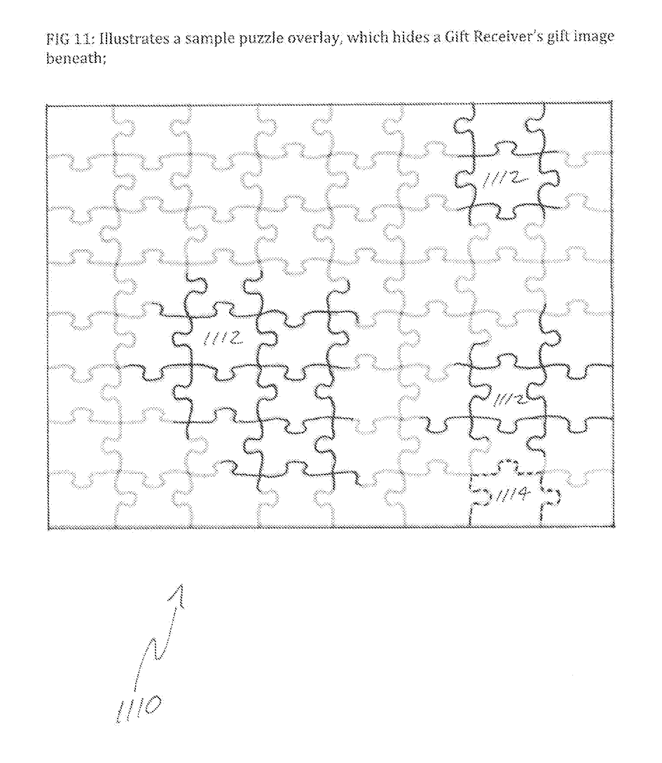

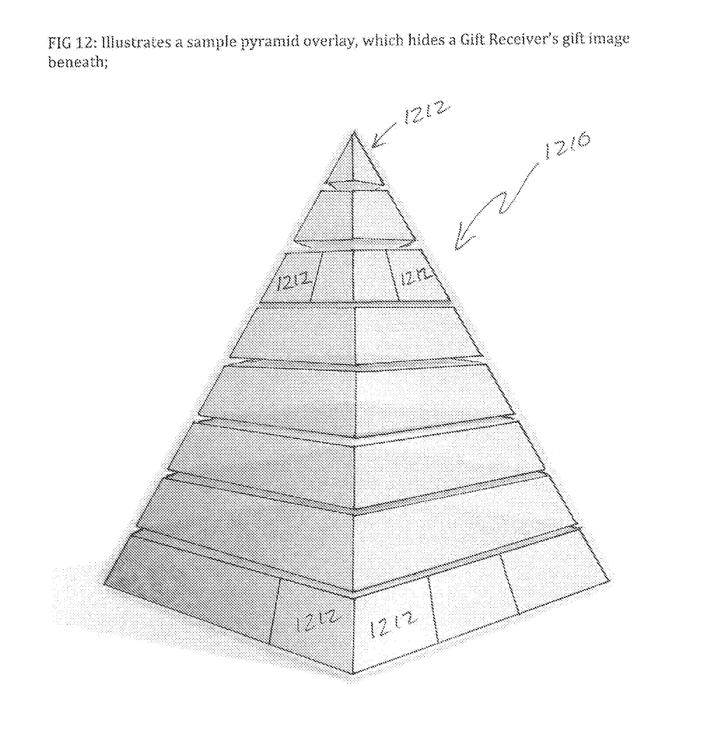

In the figures the reference numerals are prefixed by the figure number. For example FIG. 1 is the “100” series. FIG. 2 is the “200” series and so on. In addition like features between different embodiments of different figures may be indicated by like reference numerals, for example a gift portion of a puzzle piece 1112 of FIG. 11 and the alternate gift portion of a block of pyramid 1212 of FIG. 12.

### DETAILED DESCRIPTION OF THE PREFERRED EMBODIMENTS

There is a global need to solve the problems for both gift recipients, gift providers and gift givers that are inherent in the wishing well type registry process. These problems are to do with a lack of humanity and lack of personal connection in the direct donation of money to a gift recipient. In addition, the gift recipient or recipients need to be better able to choose a more expensive gift or high value gift should they so choose, or a gift at a price point that is only obtainable by the efficient collaboration of all or a sufficient number of guests as potential gift givers.

A gift recipient or recipients traditionally in the past had no time saving tools to facilitate the desired collaboration amongst their guests to purchase a high value gift. For example at best the gift recipient could email out or otherwise communicate to potential gift givers, guest list or group of guests their wish for a particular gift. However it would then be up to the guests to organise amongst themselves the collective purchase the expensive gift. The task of organising gift givers for the expensive gift collective purchase may be an onerous task for a guest or friend of the gift recipient. In addition there is a substantial risk that the person organising the high value gift purchase may have to extend their personal credit in terms of purchasing an expensive gift and collecting monies from the multiple guests contributing to the expensive gift.

In addition guests at a wedding for instance, when requested to give a gift in the form of a monetary donation, need to be better able to engage in the process of collaboration among other guests to provide an alternative to the monetary donation as a collective gift. Accordingly, guests need to be better able to understand and be organised to the aims of the gift recipients and the benefit to the gift recipients in having requested the collaboration. Guests need to be better able to value and directly see their individual contribution toward the intended aim of the gift recipients. Finally, there needs to be a system whereby the guests are better able to feel appreciated and directly acknowledged for their action in contributing money, in the manner requested, by the gift recipients.

An invention for collective gift giving is described with application in all functions or situations of a celebratory nature or to a significant event, where, based on social tradition or cultural practice that guests attending the function will offer to the host or beneficiary of the function a gift of some description. In the case of a wedding for example, the bride and groom may, because of custom, reasonably anticipate that their guests will wish to provide them with one or more gifts. The bride and groom may wish to not provide any suggestion or guidance at all as to what gift or gifts they would like to receive, preferring a gift provider such as a parent or close relative to make a choice for them for a high value gift/s.

Alternatively, the bride and groom as gift recipients may wish to actively focus and orchestrate the gift-buying effort on behalf of their guests. To that end, they may establish a number of high value gift options, in a list or a register, they would like to receive and provide their guests with access to that register as a means of collectively selecting a high value gift.

Alternatively, the bride and groom may notify their guests that they wish to receive no physical gifts but instead receive a service such as a pre-booked travel package, for example a luxury honeymoon. Other examples of services may be: a dinner at a premier restaurant, provide a contribution to an aid project in the third world such as facilitate a purchase of a cow and other livestock, clean water infrastructure, toilet and sewer services and the like, farm machinery, construction of a school and provision of educational services such as the salary of a teacher for five years. A further example of a service for the benefit of a third party would be any number of charitable causes that may exist in the locale of the bride and groom, for example education programs for disadvantaged children and funding research to cancer treatments and cancer diagnostics.

In the above and the below the example significant event or gift occasion of a wedding is used together with the gift recipients being a bride and a groom, Optionally the gift provider may be a parent or other significant relation or friend. It will be readily appreciated that other significant events that the invention may be applied and used for are birthdays such as 21^{st}, 40^{th} and 60^{th}, wedding anniversaries, births, baby showers, religious events such as Christmas, Baptisms, Holy Communion. Bar Mitzvah, undertaking a tzedakah (charity) project associated with a Bar Mitzvah and the like in other religions. Gift recipients and gift providers for significant events may include parents and other relatives, community groups, school groups and any individual who may wish to target a pool of potential gift givers/guest list to collectively purchase a high value gift to be associated with a significant event.

The invention provides a method and a system for gift recipients or gift providers to remotely orchestrate or otherwise organise the purchase of a high value gift by a group of potential gift givers.

The gift collective invention may be best implemented through the use of an internet website with remote computer servers, with associated processor/s and memories. The internet website is the preferred option for implementation currently but further and alternative options for implementation of the Invention will in future become available. Alternatively the invention may in part or wholly be performed and interacted with via a stand-alone computer, tablet, smart phone, computerised personal organiser or other handheld electronic device. Examples where an internet connection may not be used may be at gatherings of potential gift givers for a significant event where the gift provider may personally circulate amongst the potential gift givers to enlist or otherwise enrol the potential gift givers in collectively purchasing the high value gift. In addition the potential gift givers may be a closed group of gift givers who do not wish their actions to be revealed to public social media websites. In such closed social media situations, social media such as Facebook for example may only operate to security setting and/or sharing settings to a limited pool of gift givers. Similarly email lists and email forwarding may be limited. Examples of such limitations may be applied in the corporate or company environment for computer network servers, email servers and the like within that defined environment.

The Gift Collective is an invention that may be applied to replacing “wishing-well” or “contribution” style gift registries. Instead of each guest or gift giver acting unilaterally in the decision of what to offer by way of a gift, including acting unilaterally in regards to the purchase of that gift, or instead of the recipient requesting that the guests make a straight-forward monetary donation as a means of offering a gift, The Gift Collective is an invention that better facilitates collaboration and interactions between all or a significant number of guests attending the relevant function, for example. Those guests being potential gift givers. In addition to merely facilitating that collaboration, The Gift Collective invention achieves collaboration and interaction amongst the guests in a manner that is highly socially acceptable both for the recipient or recipients of the gift and among the guests themselves who may be attending the relevant function, for example. Indeed the invention may further increase the level of ownership, commitment, participation and anticipation amongst the guests/gift givers towards the significant event. The invention provides means for facilitating, controlling, or otherwise organising and orchestrating the interactions between the guests/gift givers to a common goal of the high value gift for the significant event.

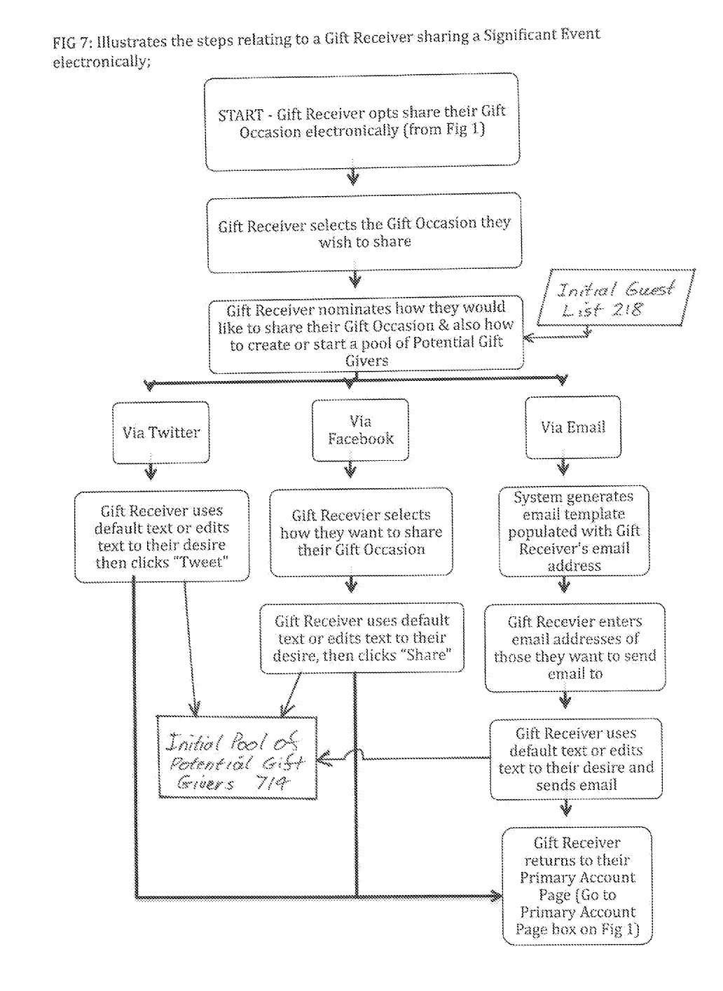

In addition positive feedback, from gift givers who have participated in the purchase of a gift portion, to the pool of potential gift givers may increase the number of potential gift givers who proceed to purchasing a gift portion or segment for themselves. Such positive feedback is described further with respect to the flowcharts of FIGS. 7, 9 and 10

The invention enables a customer such as a gift recipient or gift provider, for any gift occasion, to choose to receive one gift or several gifts and for that gift or gifts to be displayed to their guests on an internet website (as the preferred option or instrument for display). Displayed on the internet website, the guests may see the gift item broken up or having been delineated into a number of individual components so that the gift is divided into a number of gift portions. It is not intended that one guest purchases the high value gift item in its entirety, but rather that all guests each purchase one or a number of the individual components of the gift as gift portions. The gift portions having been each assigned a monetary value. It is therefore through the operation and organisation of all guests/gift givers individually purchasing either single or multiple components as gift portions that the entire funds required for the purchase of the whole high value gift which may be also an aim or a benefit, as represented in the image displayed, are attained.

### Further Methods and Systems of the Invention.

The Invention may include: a process of or means for dividing an image of the high value gift into a number of individual components or portions for sale by each component; the publication of that gift image online for viewing by guests/potential gift givers who may attend or otherwise participate in a significant event such as a future celebration, or donors for a charitable cause or for any purpose: and the facilitation of guests, donors or users making a monetary contribution toward the gift or aim or benefit that is the subject of the image displayed. The image may be displayed by a suitable graphical user interface (GUI). A display means of the GUI is further described below with respect to FIGS. 11 to 21. The GUI may also be used by gift recipients or gift providers for dividing the gift image into selectively removable segments or gift portions. The GUI may also be used by gift givers to select gift portions of the image. A selecting means for the GUI is further described with respect to FIGS. 11 to 21 and 1 to 10. A means for indicating the selection of the gift portion is further described with respect to FIGS. 11 to 21 and elsewhere.

The Invention may encompass any instance, operation or methodology whereby an image as a whole is divided to appear as having been made up of individual components or portions. The Gift Collective is an invention whereby the image of an item that has been chosen as a gift by the gift recipient or for and on behalf of a gift recipient or recipients for example, is pictorially represented as being made up of a number of components. Further, the Invention encompasses any and all patterns or imagery or overlay designs that may delineate the individual components or portions of the image or goal or intended aim of the user in accessing the Invention.

That is, the Invention encompasses any and all pictorial representations of any object or aim whatsoever, whether for the purposes of procurement as a gift or experience, or for the purposes of achieving collaboration between gift givers for any aim or benefit whatsoever, as being attainable incrementally. The overlay designs may be opaque or translucent overlays to the gift image, the gift image being progressively revealed as each gift portion or segment is selected.

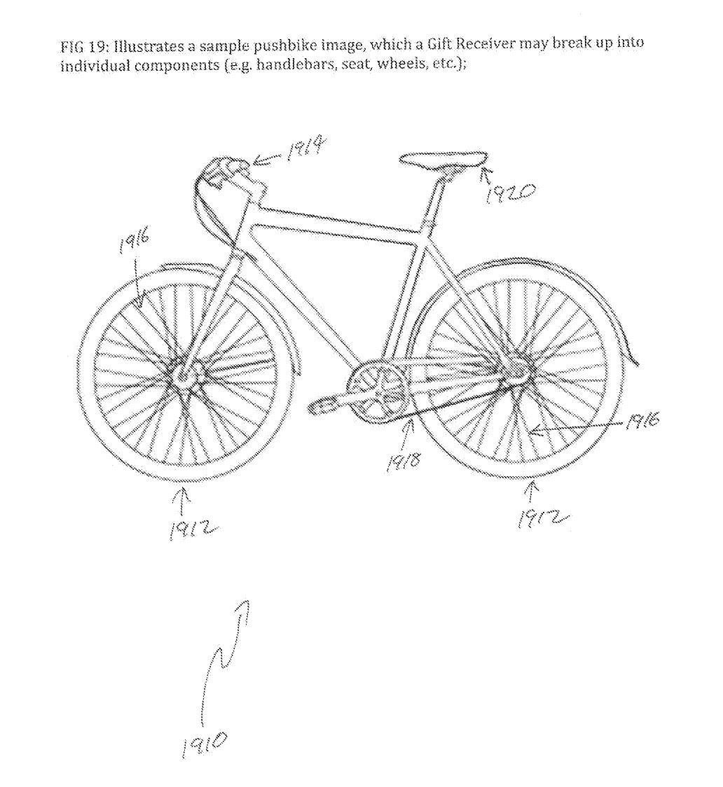

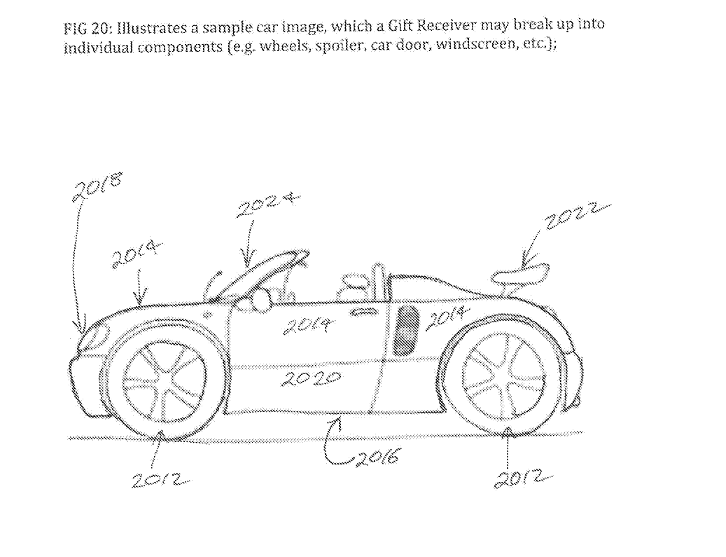

It will be readily appreciated that whilst two dimensional images or pictures of the gift may be inferred from the above that the invention also is applicable to the high value gift being represented by a rotatable three dimensional image. That is the potential givers via the GUI may rotate the three dimensional image to obtain different views of the image and select different portions of the gift that otherwise may not be viewable with a two dimensional representation. An example of such is described below with respect to FIGS. 19 and 20. In FIGS. 19 and 20 a bicycle and a car are shown as example high value gift items that are also suitable for displaying with a three dimensional image that may be rotated within a two dimensional GUI display in order for the potential gift giver to view all the gift portions.

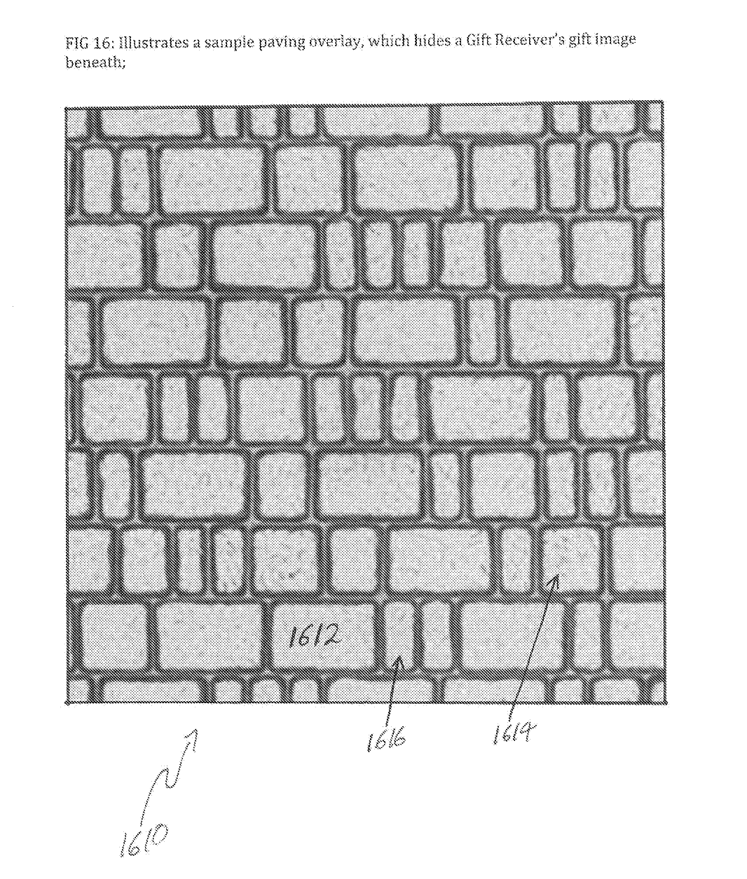

The Invention relates specifically to the many and varied patterns, images and overlay designs that may be used as a method of delineation of gift portions or otherwise dividing of an image. The Invention further relates to the individual components, the purchase of which by a guest or user arriving at the website by way of invitation or otherwise, achieves the incremental realisation of the aim of the gift recipient or customer. That is, the gift recipient or customer or gift provider may vary not only the appearance of the pattern or image or overlay design to delineate the gift portions of the image, see as described below with respect to FIGS. 11 to 18, but they may also vary the value or price of the individual components or gift portions once the image is rendered into its delineated parts. For example some gift portions may be appreciated by some gift givers as being higher value. FIG. 20 as described below provides an example of such with respect to the different components of a car being different valued gift portions which together form the high value gift item of the car. In addition the different sized paving stones of FIG. 16, described below, provide another pricing option for gift portions.

As well as overlaying a pattern upon the gift image to divide the gift into gift portions the gift recipient or gift provider may alternatively create the delineation manually, by tracing out with a suitable tool in the GUI, the gift portions within the image of the gift. For example an expensive dining table and chairs with a dining setting of plates, cutlery and glasses may be divided manually into gift portions by the gift recipient or the gift provider in the GUI. The legs may be nominated and delineated or traced out as individual gift portions, similarly the chairs as individual gift portions. The plates may be individually delineated by tracing but nominated as a single gift portion for the plate set, in a similar fashion the cutlery and glasses may also be divided into gift portions and sets. As each gift portion or segment is selected then the part of the image substantially corresponding to the gift portion that has been divided manually is revealed. For example a chair is revealed when a chair gift portion or segment is selected and/or purchased by a gift giver. Gift portions or segments that correspond with actual components of the gift are described in detail with respect to FIGS. 19, 20 and 21.

The dividing of an image that is either a gift or aim or benefit into individual components/gift portions operates to visually represent the value and meaning of each guest/gift giver's financial contribution toward the attainment of the gift or aim or benefit. The Invention operates to visually represent the collaborative effort among guests or users by illustrating how many donations made in series can combine to achieve the attainment of a greater gift or aim or benefit.

### Examples or Embodiments of the Invention

In a first embodiment of the Invention, the gift item is displayed on the internet website, being the preferred option for implementation currently but further and alternative options for implementation of the Invention will in future become available. The delineation of the individual components to gift portions of the image is in the form of a jigsaw puzzle 1110 as shown in FIG. 11. In this first example, the individual components of the image available for purchase by the guests attending the wedding for example, are in the form of individual jigsaw puzzle pieces 1112. Where each puzzle piece 1112 is a gift portion.

The gift image may be progressively revealed as individual puzzle pieces are selected by each of the gift giver. The GUI would display to all viewers the current number of gift portions purchased by how much of the image of the high value gift is revealed. Alternatively the jigsaw puzzle pattern may overlay the image so that the gift image may still be viewed through the jigsaw puzzle pattern. As each gift portion is selected and purchased by a gift giver the purchase of that particular gift portion may be indicated by a highlighting, greying or display of an icon with the purchased gift option.

A selected but pending purchase gift portion 1114 is shown with dashed lines delineating the puzzle piece gift portion. When the gift portion has been selected then the solid delineation of the puzzle piece may be used as shown for puzzle pieces/gift portions 1112. It will be readily appreciated that other visual or textual indicators may be used to indicate the status of a particular gift portion, as described herein.

In addition to the GUI displaying and otherwise indicating the status of gift portions purchased the GUI may also communicate with a computer processor to provide updates to social media of the progress of the gift portion purchasing. Interactions between the GUI processor and social media are described below and with respect to FIGS. 7, 9 and 10.

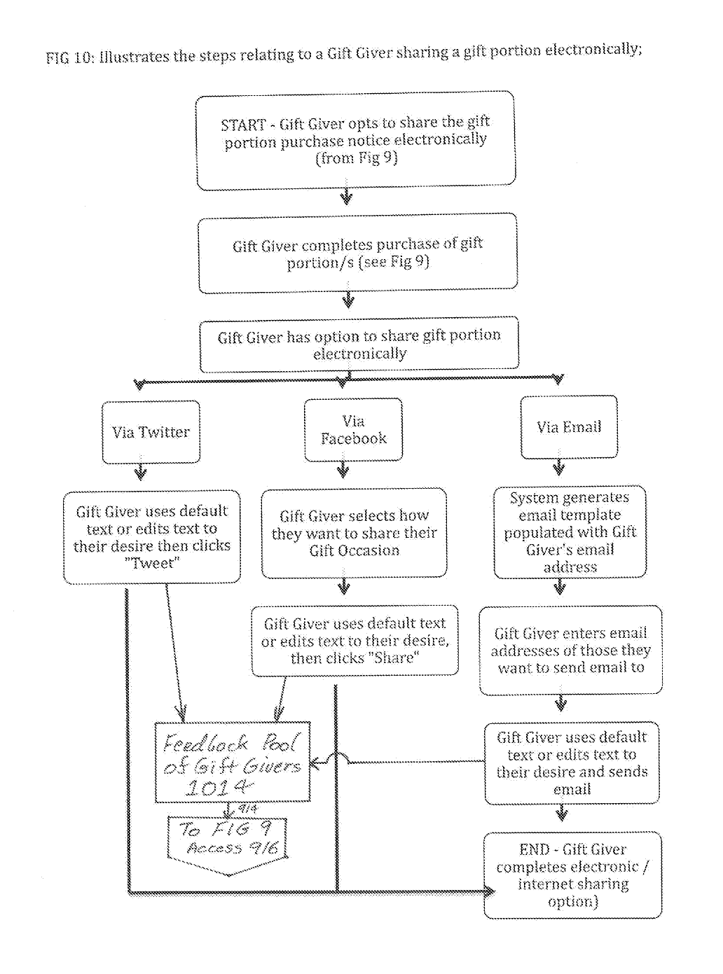

Another method of indicating a purchased gift portion by a particular gift giver may be a use of icons or other identification pop-ups associated with an identifier for the particular gift giver. For example the identifier for the particular gift giver may be as used by the particular gift giver on their social media. The social media may be as described below with reference to FIG. 10.

Identifying a particular gift giver of a gift portion in the social media may provide advantages to encouraging potential gift givers to purchase a gift portion. It may also provide an advantage to recruiting more potential gift givers by actively engaging social media.

It will be readily appreciated that the image may also display a number of gifts which are together described by the gift recipient.

A second example of the application of the Invention in the delineation of gift portions of an image, the subject of which is the gift item, aim or benefit, is in the form of a pyramid 1210 as shown in FIG. 12. The pyramid is a pictorial representation which illustrates that only by individual users purchasing individual components, the blocks 1212 in the pyramid in this example, can the pyramid be made complete. The purchase of each individual pyramid block 1212 represents the progressive collaborative effort and the progressive accumulation of funds towards to attaining the gift item, aim or benefit for the significant event.

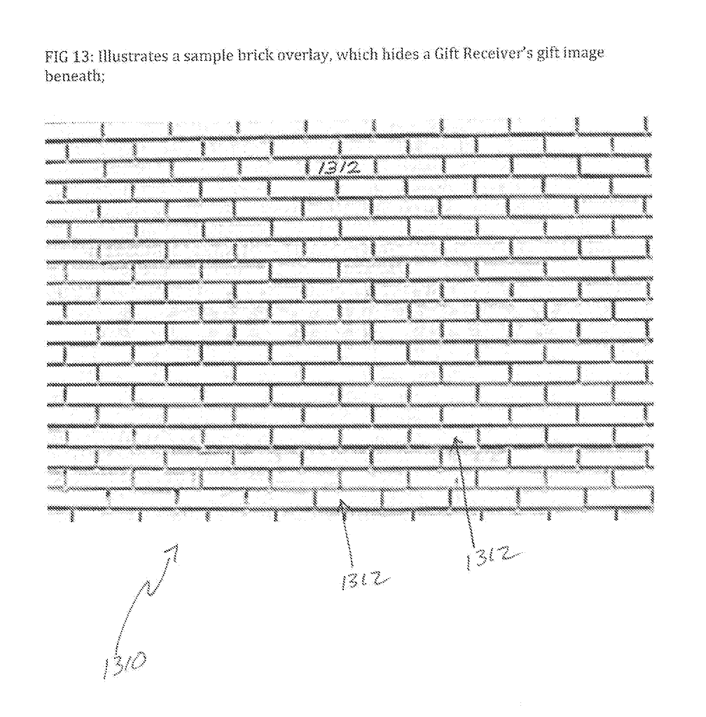

A third example of the application of the Invention in the delineation of gift portions of an image, the subject of which is the gift item, aim or benefit, is in the form of a brick pattern as shown in FIG. 13. The brick pattern 1310 is a pictorial representation which illustrates that only by individual users purchasing individual components, the bricks 1312 in the brick pattern in this example of gift portions, can the building, or home deposit, or hospital wing for instance, be made complete for a high value gift item which may be a building of some description. The purchase of each individual brick 1312 represents the progressive collaborative effort and the progressive accumulation of funds sufficient to attain the gift item, aim or benefit.

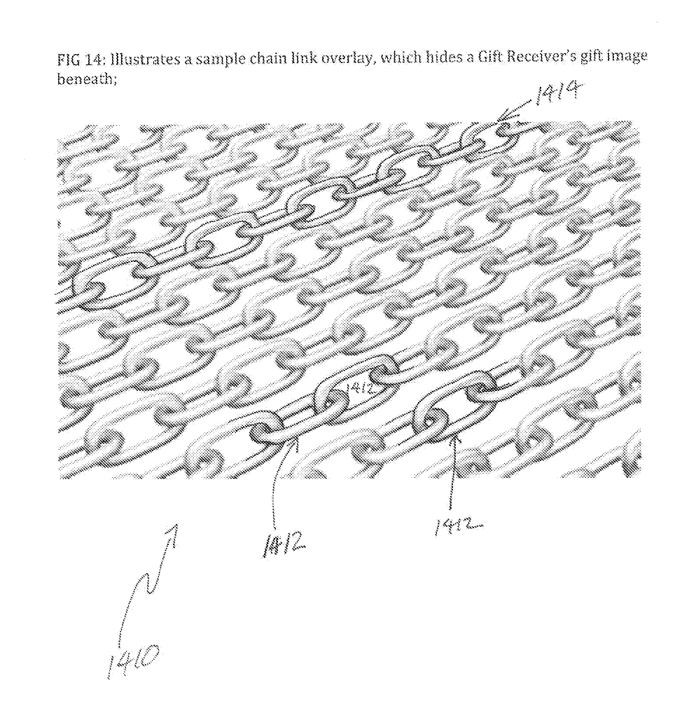

A fourth example of the application of the Invention in the delineation of gift portions of an image, the subject of which is the gift item, aim or benefit, is in the form of chain links as shown in FIG. 14. The chain links 1410 or chain links pattern are a pictorial representation which illustrates that only by individual users purchasing individual components, a link 1412 in a chain in this example, can the goal or target or destination for instance, be made complete. Alternatively a gift giver may select and purchase an entire chain length 1414. The purchase of each individual link 1412 amongst the multiple chains 1410 represents the collaborative effort and the accumulation of funds sufficient to attain the gift item, aim or benefit.

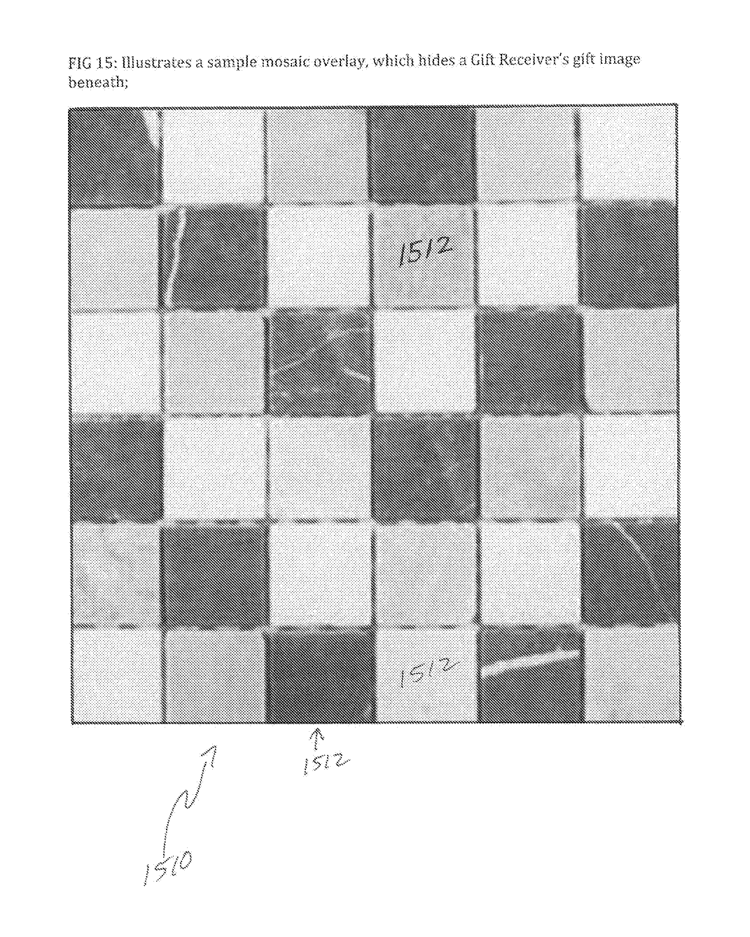

A fifth example of the application of the Invention in the delineation of gift portions an image, the subject of which is the gift item, aim or benefit, is in the form of a mosaic as shown in FIG. 15. The mosaic pattern 1510 is a pictorial representation which illustrates that only by individual users purchasing individual components, the mosaic tiles 1512 in this example, can the gift item, aim or benefit for instance, be made complete. The purchase of each individual mosaic tile 1512 represents the collaborative effort and the accumulation of funds sufficient to attain the gift item, aim or benefit.

A sixth example of the application of the Invention in the delineation of the gift portions of an image, the subject of which is the gift item, aim or benefit, is in the form of a paving or stepping stone pattern as shown in FIG. 16. The paving or stepping stone pattern 1610 is a pictorial representation which illustrates that only by individual users purchasing individual components, the paving or stepping stones 1612, 1614, 1616 in this example, can the road, or journey or airline ticket for a travel service for instance, be made complete. The purchase of each individual paving or stepping stone 1612 represents the collaborative effort and the accumulation of funds sufficient to attain the gift item, aim or benefit. In addition the different sized paving stones may be used to represent different valued gift portions. For example the full paver stone 1612 may be a full cost gift portion, a half paver stone 1614 may be a half cost gift portion and a quarter paving stone 1616 may be a quarter cost gift portion.

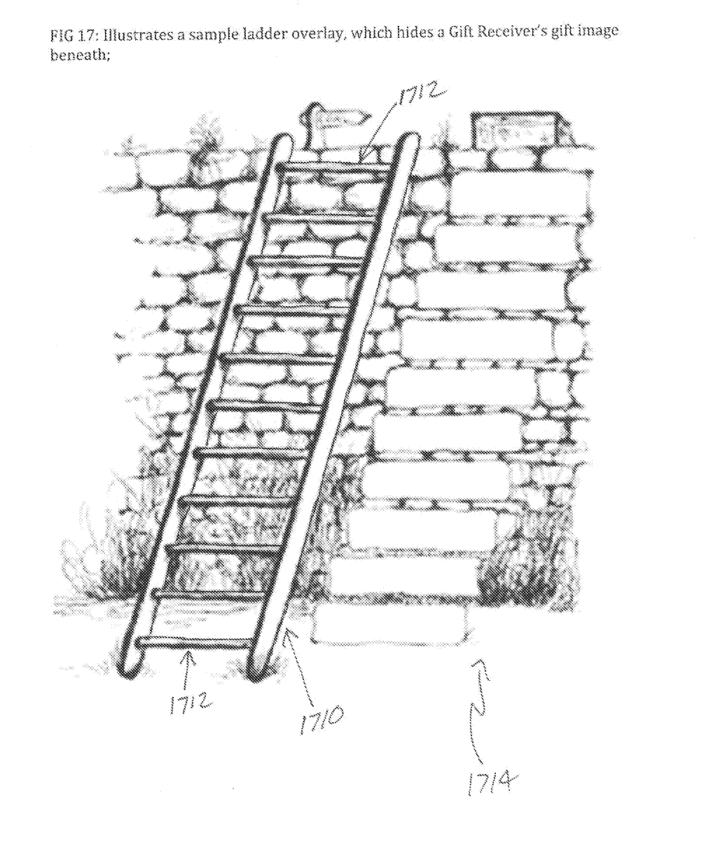

A seventh example of the application of the Invention in a different delineation of parts of an image, the subject of which is the gift item, aim or benefit, is in the form of a ladder 1710 as shown in FIG. 17. The ladder 1710 is part of the overall image 1714, with the ladder only representing the high value gift. The ladder 1710 is a pictorial representation which illustrates that only by individual users purchasing individual components or gift portions, the rungs 1712 of the ladder in this example, can the funding goal or research grant for instance, be made complete. The purchase of each individual rung 1712 as a gift portion in the ladder 1710 symbol of the high value gift, represents the collaborative effort and the progressive accumulation of funds sufficient to attain the high value gift item, aim or benefit. In one example, as a rung of the ladder is purchased as a gift portion, then a horizontal band of the image, including the purchased rung, may become transparent to progressively reveal part of the underlying gift.

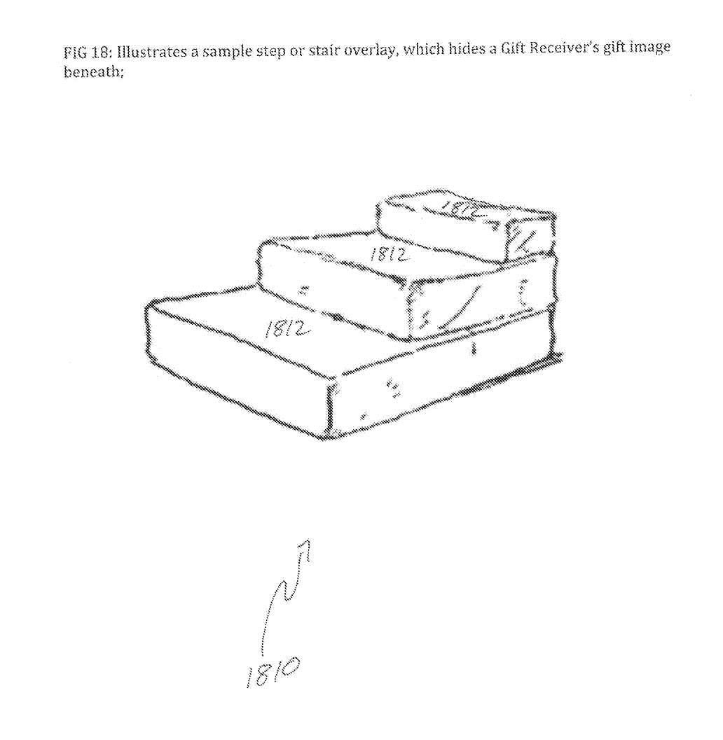

An eighth example of the application of the Invention in the delineation of into gift portions of an image, the subject of which is the gift item, aim or benefit, is in the form of steps 1812 for stairs 1810 as shown FIG. 18. The stairs 1810 are a pictorial representation which illustrates that only by individual users purchasing individual components, the individual steps 1812 as gift portions in this example, can the gift item, aim or benefit be made complete. The purchase of each individual step 1812 represents the collaborative effort and the accumulation of funds sufficient to attain the gift item, aim or benefit.

A ninth example of the application of the Invention in another different delineation or dividing into gift portions of an image, the subject of which is the gift item, aim or benefit, is in the form of an image that the user manually delineates and/or nominates into its individual components. For example, a user, gift recipient or gift provider may wish guests attending her or his birthday party to collaborate in order to raise the required funds to purchase a bicycle 1910 as shown in FIG. 19. In this example, the Invention encompasses the user in this case manually delineating the image of the bicycle in the GUI so that the each wheel rim and tyre 1912, the handlebar 1914, a spoke set 1916 or individual spokes, a chain 1918, a seat 1920, pedals 1922 and the like for instance, form individual components as gift portions for individual purchase. Alternatively the supplier or manufacturer of the bicycle 1910 may supply a pre-loaded template to the GUI which divides the bicycle image 1910 into off-the-shelf items as gift portions. In another embodiment an administrator of the website may also configure or otherwise supply a template for dividing into component gift portions high value gifts such as bicycles and further below to FIG. 20.

The bicycle overlay of the bicycle gift image delineates components of the gift image such that as each segment of the component overlay is selected by one or more gift givers the corresponding component image of the bicycle gift is substantially revealed. That is the component overlay is also functioning as a symbolic overlay with symbolic gift portions or segments. For example an overlay segment symbol/s to a wheel may correspond to a wheel component of the desired bicycle gift.

In operation symbolic segments may be assigned to particular components shown in the gift image. Similarly the monetary value or price assigned to each symbolic segment may be varied according to the component of the gift that the symbolic segment corresponds to.

In the example of FIG. 19, the user, website administrator, the supplier, the manufacturer, gift recipient or the gift provider may also vary the price or monetary value for each component which is a gift portion or segment. The separation of the parts of the bicycle itself serves as a pictorial representation which illustrates that only by individual users purchasing individual components can the bicycle 1910 be made complete and suitable for then gifting by the collective of gift givers. The purchase of each individual part represents the collaborative effort and the progressive accumulation of funds sufficient to make possible the purchase of the bicycle 1910 in this example.

A tenth example of the application of the Invention in the delineation of an image into gift portions, the subject of which is the gift item, aim or benefit, is in the form of an image that the user manually delineates and/or nominates into its individual components the gift portions. Alternatively the division into gift portions may also be as described above with respect to FIG. 19 and the bicycle 1910 example. For example, a user may wish guests attending her or his birthday party to collaborate in order to not only raise the required funds to purchase a motorcar 2010 as shown in FIG. 20, but for the guests to contribute toward to customisation of the motorcar 2010 in the manner desired by the gift receiver/recipient or a gift provider such as a parent, a spouse or a partner for example. In the FIG. 20, the Invention encompasses the user, gift recipient, gift provider or the like manually delineating the image of the car into symbolic gift portions/symbolic segments.

As described earlier the car 2010 may also be suitable for representing as a three dimensional image on the GUI so that all views of the exterior components that may be suitable as gift portions may be viewed. For example the wheels 2012, panels 2014 of the sides, boot and bonnet, an exhaust system 2016, headlight style 2018, door 2020, spoiler 2022, windscreen 2024 and the like. In addition the GUI may allow for interior views of the car cabin interior trim, upholstery, seat types, sound system, instrumentation panel and the like may be viewed as possible gift portions. In a similar fashion views of the car engine compartment may be made available by the GUI so that other possible gift portions may be seen and selected. For example the engine block, intercooler, electronic fuel injection versus multiple carburetors and so forth.

It will also be readily appreciated that car performance features not readily viewable may also be made available as gift portions by icons or drop down menus on the GUI. For example the icons or drop down menus may be associated with the car image 2010. Examples of such non-viewable car performance features may be an enhanced safety pack of curtain air bags, crash avoidance radar/systems, security features and selectable engine and transmission performance modes of race, sport, motorway, safe and learner.

In addition for the embodiment of FIG. 20, selecting custom additions or upgrades to individual gift portions may done. For example, a particular tyre or rim of a wheel may be upgraded to an alloy rim with low profile or race tyres, a particular paint colour scheme selected, car seat cover material, sound system and so forth. Each custom accessory upgrade to the gift portion then forms another commodity for sale individually which may either be linked to the original gift portion, for example a wheel set 2012, or offered as a separate gift portion once the wheel set 2012 has been selected and purchased, for example upgrading the purchased wheel set to alloy rims. The price and options for upgrading and/or customising each component gift portion may be that as set by the car manufacturer or car supplier for the inclusion of each accessory or item. The Invention therefore includes the process by which the image of the car, in this example, is modified according to the tastes of the recipient of it and the subsequent processes that link the display and the sale of the customisable options through to the delivery of the car complete with chosen extra features and custom options. In this example, the Invention may or may not apply to the purchase price of the car. For instance, where the purchase of the car is already made or the car is already to be ordered in the baseline model, then the Invention may be used as a gifting platform to add, modify or otherwise customise the car by nominating or otherwise assigning gift portions to components or features of the car 2010 which may be customised and/or upgraded. The separation of the custom features of the car serves as a pictorial representation which illustrates that an item that may already be going to be given as a gift, may by use of the Invention, be modified, enhanced, added to or otherwise upgraded by individual users purchasing individual modifications, enhancements or upgrade components that may serve to create a greater experience or enjoyment of the gift item by all those involved: gift givers, gift recipient and gift provider.

An example of another embodiment of the invention to the customisation or upgrading of an already owned asset may be an already owned four wheel drive (4WD) utility or pick-up truck of the gift recipient. The invention may be applied to providing gift options to the 4WD pick-up such as driving lights, a winch, a large aerial and CB radio amplifier, a 2-way radio, a GPS navigator, fishing rod holders, a long range fuel tank and similar accessories. The gift portions may be configured to divide an individual gift option or group together a number of gift option accessories and then divide the group into gift portions.

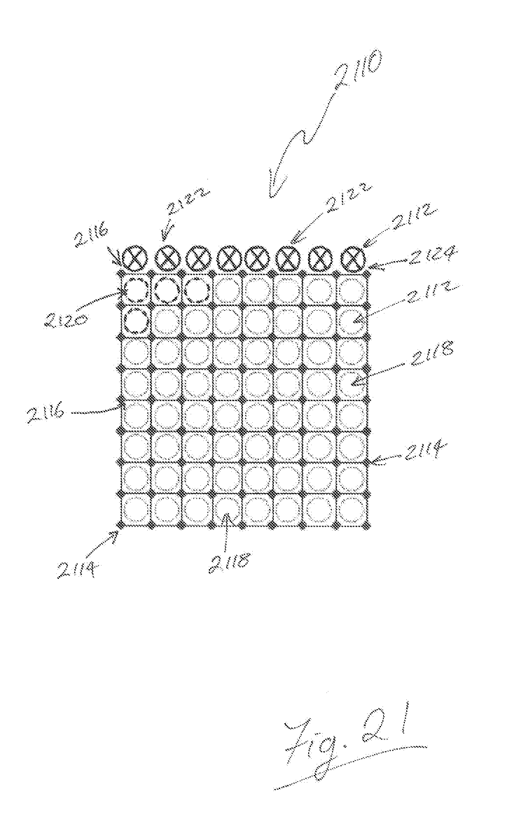

FIG. 21 is another example of the invention for a “Cellar Party” for the purchase of wine bottles either as a collective gift, an individual or group of individuals purchasing wine bottles for themselves or for a fundraising event. FIG. 21 schematically shows part of a GUI (graphical user interface) representing a front view of a wine rack with wine bottles 2110. The wine rack 2114 is represented as a cellular rack with multiple rows of cells 2116 or spaces 2116 for the placing of wine bottles 2112 laid down in a similar fashion to how actual wine bottles may be stored in a real cellar. That is the bottoms of the virtual wine bottles 2112 as gift portions are shown in the front view of the wine rack 2014.

In a first applied form of FIG. 21 the GUI of the wine rack 2110 may be pre-populated with wine bottles to represent the wine bottles stocked or supplied by a wine retailer and/or wholesaler. A gift giver or purchaser may browse the rack of bottles by use of a mouse pointer, their finger or other pointing device for example, to activate a pop up icon or window which gives provides some details to the wine bottle. The pop-up icon or window may provide such information as price, name of the wine, brand of the wine, drinking qualities and any other such information typically applied to or associated with wine bottles. Alternatively the individual bottle ends 2112 may have information to the wine bottle associated or represented by that particular gift portion 2112. In a similar fashion to other examples of the invention the wine bottle gift portions 2112 may be symbolic and correspond with actual wine bottle gifts. In addition the collective gift may be considered the collection of wine bottles in the full or otherwise completed wine rack 2110.

Wine bottles 2118 that have not been selected may be represented as open ended bottles ends as shown in FIG. 21. In addition a dashed line delineation 2120 or the like may be used to provide further visual differentiation within the GUI for the gift giver. Selected wine bottles 2122 may be represented by a solid or a bold line delineation with a cross as shown for example with the top rack 2124 of wine bottles 2122 in FIG. 21. As the purchaser/gift giver progresses in selecting bottles for purchasing/gifting then those selected bottles 2122 are indicated on the wine rack 2110 as selected 2122. In this form of FIG. 21 the selection of gift portions 2112 does not reveal a portion of an image or photograph of the actual gift but indicates the purchase of the wine bottle gift portion 2112 of the collective gift or wine bottles that may be finally purchased by others.

Variations to the first applied form of the FIG. 21 example and the other forms described herein are as follows. Each wine bottle may have the same value or alternatively, each wine bottle may have an individual price. Gift giver guests may select according to preferences in wine or in price. Upon selection of the gift portion 2112, the selected wine bottle 2122 may be rendered in full colour to indicate that it has been selected, sold and/or no longer available for gifting by other gift givers.

In a second applied form of the FIG. 21 example the GUI of the wine rack 2110 may initially be unpopulated so that all the wine bottles 2112 are represented or otherwise indicated as unselected wine bottles 2118. Alternatively the spaces or cells 2116 for in the wine rack 2114 may be shown empty, that is the wine rack 2114 is initially shown empty of wine bottles 2112, 2118, 2122. As the gift giver or purchaser selects a wine bottle and inserts it into the wine rack 2114 with the GUI then the selected wine bottle may be shown as for the first applied form, for example as a selected wine bottle 2122. Empty spaces or cells 2116 of the wine rack 2114 may provide inducement to the other gift givers or potential gift givers to fulfil a purchasing goal set by the number of cells 2116 for wine bottles 2112 in the wine rack 2114.

Variations to the second applied form and the other forms described herein are as follows. The “Cellar” as may be represented by the wine rack 2110 or other symbolic image or GUI may initially be empty and it will be up to gift giver guests to select their own bottle of wine to fill the “Cellar”. Wine may be selected from any store or affiliate retail brand whose online sales catalogue is accessible to gift giver guests accessing The Gift Collective website of the invention.

The “cellar party” invention example of FIG. 21 may be done via a gift giver's or other purchaser's personal communication device in their own residence, work-place or other convenient place. Communication devices such as hand held mobile or cell telephones, tablets, personal organisers and the like may be suitable. Alternatively the invention may be used in an actual significant event or location such as a wine cellar, a social gathering venue, a party, a fundraising event or the like as part of a wine sampling, tasting and purchasing function. The invention may enable each purchasing group to review wines for tasting, select and purchase all from their table or other location in the venue. For example couples visiting a winery may be able to use a tablet computer on a mobile/cell telephone application (“app”) to undertake wine tasting and purchasing. Similarly larger groups may also do the same with a singular or multiple tablet computers and the like to make group decisions and purchases. The invention GUI may facilitate the ease with which information for decision making to tasting and/or purchasing of wine bottles by the gift giver or other purchaser may be made.

The use of a mobile or cell telephone software application (“app” as often termed) at a significant event may be activated on a guest's telephone when the gift giver guest attends the significant event function. For example the guest gift giver may have already supplied their mobile/cell telephone number to allow communication of the software application to their hand held mobile device when they arrive. In this case, an app may facilitate the selection and purchase of gifts. The “app” may appear on a gift giver guest's mobile communication device while attending the function. The app would allow the display, consideration, purchase and gifting of individual bottles of wine, in real time at the function. As the gift giver guests purchase gifts, the Cellar “app” may displays the incremental fulfillment of the components of the wine rack with the identity (e.g. Facebook photograph) of the gift giver, and/or the actual bottle or bottles or cases of wine to all those attending the function and/or just the gift recipient.

It will be readily appreciated that other GUI representations of a collection of bottles may be used and still achieve the invention. In a similar fashion the size and shape of the wine rack may be varied according to the anticipated purchasing goals of a group of gift givers or purchasers in general. Further variations or forms to the example of FIG. 21 are provided below.

The wine rack style of gift puzzle may be set at various price points. For example, $1,000, $5,000 or $10,000 which may be called “Bronze” “Silver” and “Gold” Wine Gift Puzzles or wine rack gift sets. Custom or “Platinum” service lists may be further alternatives to service level and price point. The wine bottles 2112 may also be varied in any number of combinations, for example according to quality and quantity of the bottles of wine. The wine rack Gift Puzzle with the gift giver guests may enable the collective establishment of a bona fide ‘Cellar’ of wine for a gift recipient by the gift givers selecting and purchasing of each wine bottle component in the wine rack.

In another alternative, the gift giver guests may upload a photograph or image/representation of themselves to the GUI so that photograph appears, instead of a bottle of wine or a wine rack. The photograph may then be divided into gift portions as described with respect to FIGS. 11 to 20. Gift givers may then contribute to the collective gift of a collection or “Cellar” of wine bottles as described with respect to FIGS. 11 to 20. Attached or sitting ‘behind’ the photograph or image may be a written description of the wine bottles as a “Cellar” that has been collectively gifted. A “Cellar” of wine bottles, as described herein, may then be established from all guests attending the significant event, such as an Engagement Party for example.

Other variations and options to the example of FIG. 21 are also as follows. The bottle of wine or bottles of wine given as gifts may automatically be linked to the gift giver progressively as the individual selections proceed. The drinking or cellaring notes of the wine or bottles of wine may be automatically linked to and provided to the bottle of wine and the gift giver. A ‘Cellar Diary’ may be generated for the gift recipient allowing them to look into the future to see what wine is best consumed at what time—accompanied by the gift giver details for each diary entry. The wine bottles may be delivered physically to the gift recipient or be delivered via an affiliate retail partner.

### Further Embodiments of the Invention

The Invention may operate to collect money from individual gift givers to be aggregated for the purpose of purchasing a larger or more expensive gift item for example, than would otherwise be achievable for any one guest or guest couple for a significant event. In the first embodiment of the Invention, being the representation of the item, aim or benefit in the form of a jigsaw puzzle 1110, it is the sale of all the individual jigsaw puzzle pieces or individual parts/gift portions that achieves the possibility of purchasing the high value gift item, aim or benefit. In such a way, it is through the collaboration and organisation of the guests provided by the invention that the customer or gift recipient acquires the high value gift item. The item or aim or benefit may be acquired as a result of guests participating in the collective and interacting together. Where the interactions between potential gift givers and those gift givers who have already selected a gift portion may be via viewing the already selected gift portions on the GUI as described above with respect to FIG. 11.

The invention may enable an “effective” purchase of the gift item as the system and method may collect the financial contribution payments from all the guests individually and directly and remits to the recipient not the gift item itself but the funds that make up either the purchase price of the gift item or an amount of money that is expected to be slightly above or below the purchase price of the gift item. The “effective” purchase does not mean the actual purchase of the item; it refers to the gift recipient being able to now make the purchase of the gift item as a result of the collaborative effort of guests who accessed the Invention and contributed a monetary amount; the combined effect of which is the addition of monies from multiple contributions sufficient to match the funds accumulated with the purchase price of the item in question. With the required funds in hand, the gift recipient is able to make the actual purchase of the gift item, aim or benefit in question.

Alternatively for the embodiments of FIGS. 19, 20 and 21 for example the invention may directly interact with the manufacturer, supplier or other such third party retailer of a suitable high value gift items such that once all gift portions are purchased, together with any optional upgrading of gift portions, the gift delivery to the gift recipient for the significant event may be then be acted on by the invention. The gift recipient and/or gift provider may simply receive a notification that the gift purchase has been completed and that delivery for the significant event may be expected at a nominated time and a nominated venue.

In yet another alternative the invention may also be applicable to high value gifts associated with service providers as described above and also service providers for charitable causes or aid projects. The invention may directly interact with the service provider at the completion of the purchase of all the gift portions to notify or otherwise communicate to the gift recipient that the gift service is now available. In addition the invention may initially interact with the service provider when a suitable high value gift is being selected by gift provider or gift recipient, for example see FIGS. 2 to 6, so that available services may only be selected as gift items by the gift provider or gift recipient.

### The Social Improvements to Collective Gift Giving by the Invention.

The Invention may overcome the problem of wishing-well type, direct financial gift registries not being considered socially or culturally acceptable, since the Invention provides an alternative to a direct financial gift to a gift recipient. Those users/gift givers accessing the GUI of the Invention for the purpose of giving a financial contribution for a gift portion as a gift do so whilst being able to see the image of what it is they are contributing to. The user may select one or many of the gift portions pieces to purchase for the benefit of the gift recipient. The gift givers by being able to see the image of what it is they are contributing toward, gift givers are able to immediately visualise and understand the aims of the gift recipient and the benefit to the gift recipient. The gift givers by being able see their individual contribution of their gift portion relative to the whole high value gift, guests/gift givers are better able to value their contribution by visually appreciating how integral each gift portion is to the attainment of the gift item, aim or benefit for the gift recipient. The experience of the user/gift giver, who accesses the Invention for the purpose of contributing money to a gift portion for a gift recipient, is enhanced by the visual presentation of the contribution of the gift portion that provides a sense of satisfaction for the user. Furthermore the gift givers are aware that the gift recipient may receive notification of each gift givers valuable contribution to the high value gift.

In addition, the Invention achieves an improvement in social media interaction both between the gift recipient or recipients, gift providers/gift givers and their guests in the preceding period prior to the occasion/significant event and as between or among the guests themselves. The Invention provides a system for the open exchange of dialogue in a discussion forum between gift givers and receivers and as between gift givers themselves by the use of social media such as Twitter, Facebook and the like internet hosted social media and chat room forums. For example as schematically shown in the flow charts of FIGS. 7, 9 and 10. The system enables gift givers to share with other gift givers and potential gift givers the fact that they have contributed to the gift item, aim or benefit and in so doing, they may inspire potential gift givers and achieve a groundswell of goodwill toward the gift recipient, charity or cause for instance, that serves to increase the probability of all gift portions being purchased. That is the use of social media to share updates to gift portion selections and purchases, as described above with respect to FIG. 10, to a potential gift giver pool or a group of gift givers. The gift giver pool for social media may be started by the gift recipient or gift provider as described below with respect to FIG. 7. In addition the gift giver's interaction with social media to provide a positive feedback to the gift giver pool in social media further amplifies the positive feedback to further potential gift givers in the pool of gift givers or guests so that they are more inclined to participate and purchase a gift portion. In other words subtle peer group pressure amongst the gift giver pool and the innate desire to participate in a joyous or worthwhile significant event by the gift givers may be invoked and reinforced further by the invention. The use of social media is also described with reference to FIG. 10 for the gift givers. Positive feedback between the gift givers is also described further with respect to FIGS. 7, 9 and 10.

The Invention is also an alternative to traditional wishing-well type registry service in the way that the system and method visually presents a view of the desired gift as an image made up of individual parts/gift portions; secondly, in the ability of guests to effectively collaborate as a collective by each guest purchasing an individual component as a gift portion; and thirdly, the characteristics of the wishing-well type registry that have been seen as socially and culturally unacceptable due to the lack of connection between a gift and the significant event have been overcome. The visual presentation of the gift item, aim or benefit together with the combined use of social media to foster discussion, personal interaction and online social engagement in the act of giving a gift achieve together achieve a level of social acceptability and reinforcement that has to date not been possible in a wishing well type registry product or service.

It is through this discussion forum that personal interaction and social engagement in the act of giving a gift may be achieved. The result gives to the gift giver the feeling of a direct personal connection or attachment to the high value gift being given to the gift recipient. This feeling is in parallel to what at the same time is an electronic commercial transaction but the system and method achieve the feeling and satisfaction of having personally delivered a one-off gift to the gift recipient as either a physical gift or a service as a gift.

The Invention may utilise social media technologies for the discussion forum to promote awareness of the gift item that is displayed on The Gift Collective website. The system may promote this awareness via the social media forums known as Facebook, Twitter, Pinterest and Instagram and may utilise further or additional social media technologies as they become available or are more widely adopted. Further descriptions to the use of social media are described below with respect to FIGS. 7 and 10.

### Further Embodiments

FIGS. 1 to 10 are flow diagrams or flow charts schematically showing embodiments of methods and systems of the invention. The gifting platform or system of FIGS. 1 to 10 and also as described above may be mounted or otherwise implemented on a computer processor and a computer memory or storage medium where the processor and the memory may reside in the one location located on a computer server. Alternatively individual or multiple processors and individual or multiple memories may be distributed across several computer sites or geographical locations with communications between the computer sites being by the internet or other communication techniques and apparatus. In another alternative distributed computing and service provision may also be by cloud computing servicing.

As described above the invention may also be performed on stand-alone devices that are not in communication with the internet or telecommunication services. For example at parties of a closed groups of gift givers. These stand-alone devices may have processor and memory sufficient to perform a standalone portion of the invention and then securely interact prior or later with computer services to perform other aspects of the invention.

The GUI may also be adapted and configured to operate stand-alone on a variety, with an associated processor and memory, hand held devices of the gift provider or gift recipient as well as potential gift givers.

The memory may be allocated to providing database services and locations for functions shown in FIGS. 1 to 10. The processors may be allocated to providing processing and computing services to the processing and calculating tasks described with respect to FIGS. 1 to 10 and elsewhere in this detailed description. For example the GUI may make use of processors located on remote computer servers as well as a hand held device of the gift recipient, gift provider and the gift givers.

It will be readily appreciated that computer processors and computer memories may be readily configured and adapted by use of appropriate software, firmware and hardware by a person skilled in the art to perform the invention as described herein.

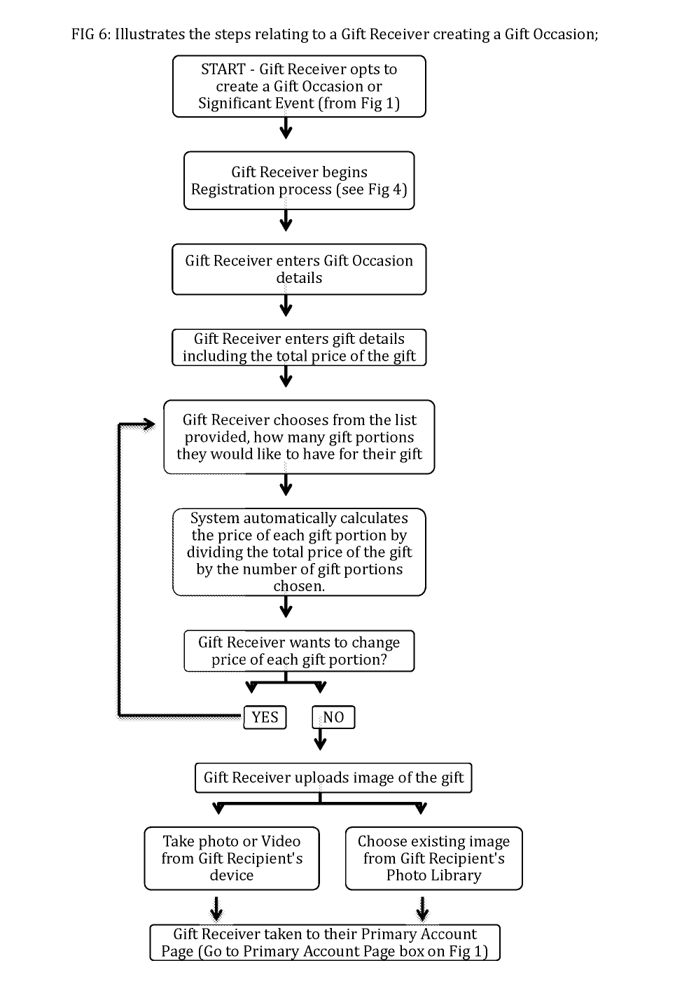

FIGS. 1 and 2 are flow charts or flow diagrams schematically showing methods and features of the gift recipient or gift providers setting up of a high value gift selection for a gift occasion or otherwise termed a significant event. In addition the gift recipient and the gift provider may set up the general orchestrating and otherwise organising of the how the gift givers interact with the GUI for the purposes of the collective purchasing of the high value gift. The gift dividing means of action “Add Gift Dividing Means” 214 and action “List of Gift Dividing Means associated with that Gift Occasion” 216 refers to embodiments of FIGS. 11 to 20 for producing the gift portions from the two dimensional or three dimensional representation of the high value gift or from gift components as per FIGS. 19 and 20. The gift dividing means is also described further with respect to FIG. 6 below.

The gift recipient or gift provider may also enter an initial guest list 218 so that the initial sharing of the gift occasion or significant event electronically may be done as described and shown with respect to FIGS. 2, 7, 9 and 10. The initial guest list 218 may also start the initial gift giver pool 714 as described and shown with respect to FIGS. 2, 7, 9 and 10.

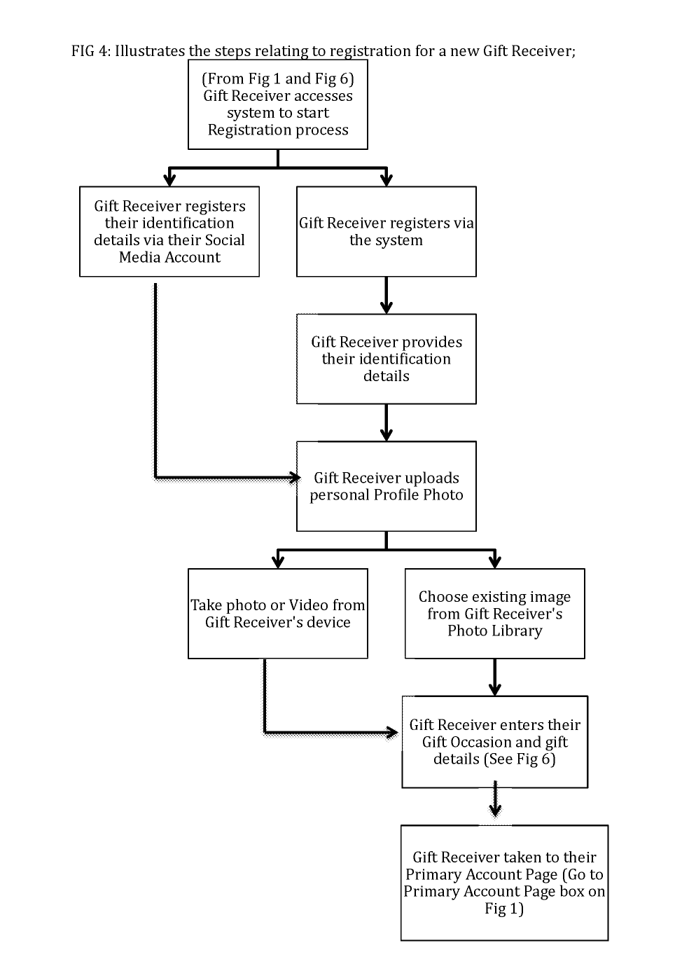

FIG. 4 provides a further flow chart to FIGS. 1 and 2 to describe the method of the gift recipient or the gift provider registering themselves to begin the set-up of FIGS. 1 and 2. It will be readily appreciated that since high value gift items may be involved that additional identification verifications may be done to aid in suppliers and manufacturers providing gifts to verify that the request for the gift service is legitimate and the address for delivery of the gift is valid.

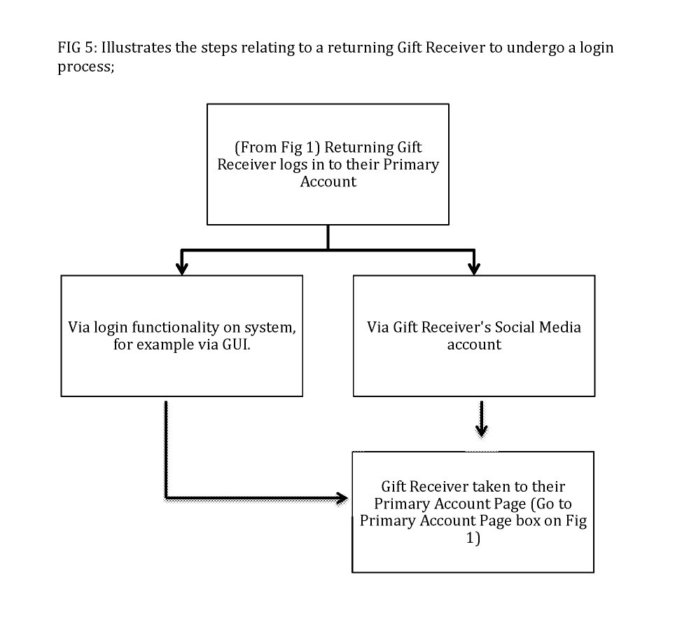

FIG. 5 is a flow chart to the login procedure for a previously registered gift recipient or gift provider.

FIG. 6 is a flow chart showing one example of a method to create and associate the high value gift with the significant event or gift occasion. FIG. 6 may also be considered to be a part of the interface to the gift recipient or gift provider. FIG. 6 also includes the gift dividing means to produce the gift portions from the gift selected by the gift recipient or gift provider. It will be readily appreciated that the additional functionality described above with respect to FIGS. 19, 20 and 21 to gift portions being assigned or nominated according to components of gifts such as a bicycle 1910, car 2010 or wine cellar, by way of example, may be additionally included in the process of FIG. 6. It will also be appreciated that the direct interactions previously described to the manufacturer or the supplier, for example FIGS. 19, 20 and 21, may also be further included in the process or method of FIG. 6.

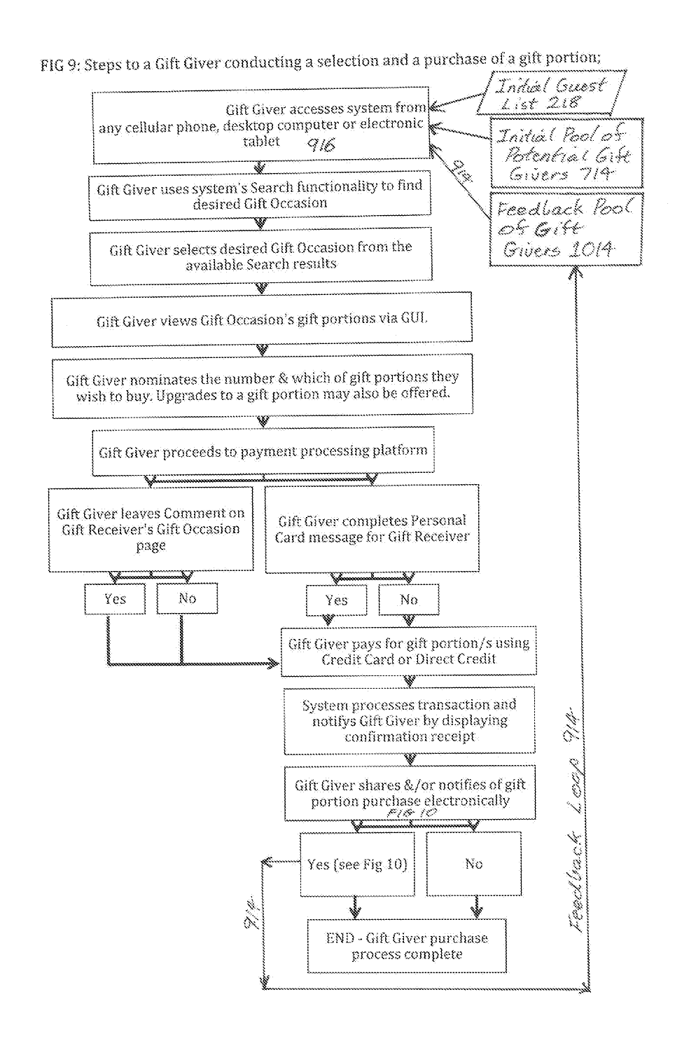

FIG. 7 shows an example of a process of the gift recipient or gift provider sharing, notifying, communicating or otherwise informing their group of guests, guest list or pool of potential gift givers of the significant event. In addition a notice and information to the high value gift associated with the significant event may also be provided to the pool of potential gift givers. Multiple options to also engage various social media as discussion and interaction forums may also be used for the benefit of the gift givers as well as the gift recipient or gift provider. It will be readily appreciated that engaging the use of social media may also favourably increase the pool of potential gift givers by the initially nominated gift givers using their social media links to alert others to the significant event with the associated gift. The use of social media by the gift givers is also further described with respect to FIGS. 9 and 10. Varying such multiple options either singularly or in combination for social media interactions may be used to vary the level of feedback loop gain as described with respect to FIGS. 9 and 10.

In FIG. 7 the initial guest list 218 may be used as the initial starting point for the initial pool of potential gift givers 714. The initial pool of potential gift givers 714 is created as shown from the inputs and sharing via social media such as Twitter and Facebook for example as well as Email and SMS with cell telephones and mobile telephones. The expansion of the initial pool of potential givers 714 is described further below with respect to FIGS. 9 and 10 and the sharing of the Significant Event described herein.

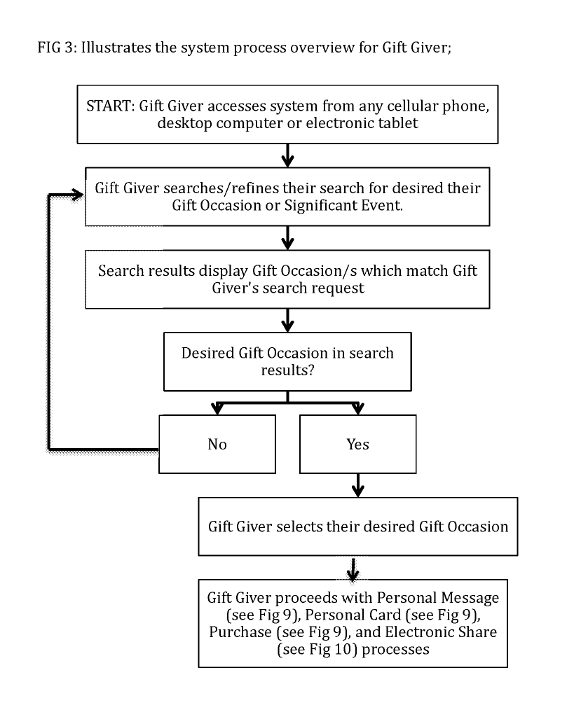

FIG. 3 is a flow chart of the initial process for a gift giver once they become aware of the significant event. For example the gift giver may become aware via the process of FIG. 7 and also as described elsewhere herein. The potential giver may also become aware by more traditional communication methods than internet based social media.

FIG. 9 is a flow chart of an example of the gift giver selecting and purchasing a gift portion of the significant event of FIG. 3. The gift giver may then engage further with social media and other electronic communications as shown in FIG. 10 and described herein. The gift giver may initially arise from the guest list 218 and/or the initial pool of potential gift givers 714. Then as the collective gift giving progresses the feedback pool of gift givers 1014 may dominate as the source of the gift givers. The feedback pool of gift givers is described below with respect to FIG. 10 and the sharing of the Significant Event herein. A feedback loop 914 is shown into the feedback pool of gift givers 1014 and then to the gift giver access 916 to purchasing a gift portion or segment. The feedback loop 914 is described further with respect to FIG. 10 and the significant even described herein.

FIG. 10 is a flow chart of an example of a gift giver's interaction with social media after selecting and purchasing a gift portion as shown in FIG. 9. It will be readily appreciated that the interactions between gift givers on social media as described herein may further included in the process shown in FIG. 10. It will also be appreciated that the interactions between gift givers and their own, further links and networks on social media may expand or multiply the pool of potential gift givers, as described previously herein, and may be further included in the process shown in FIG. 10. For example the initial pool of potential gift givers 714 initiated by the gift receiver or gift provider in FIG. 7 may expand further by interactions across social media so that more potential gift givers become aware of the Significant Event. That is the use of social media such as Twitter and Facebook as well as follow on emailing and forwarding of email may expand the number of people aware of the Significant Event and thus recruit them as potential gift givers. In addition a gift giver may provide positive feedback to the pool of gift receivers 1014 as shown in the flowchart of FIG. 10. That is the pool of gift givers forms a positive feedback pool 1014.

Gift givers who have purchased a gift portion or segment may provide two positive feedbacks to the feedback pool 1014. The first positive feedback is further progressive revealing of the gift image which initially may spark interest in potential gift givers as to what the rest of the collective gift is. In latter stages once the gift may be largely discernible through a majority of selected/purchased gift portions/segments this feedback may serve to encourage gift givers to finally complete the collective gift purchase for the gift recipient. A second positive feedback may serve to enrol potential gift givers via a desire for inclusion in the celebration of the Significant Event before all gift portions have been selected or purchased.

It will be readily appreciated that the flowcharts of FIGS. 9 and 10 may be coupled together in a feedback loop 914 by the feedback pool of gift givers 1014. The operation of this feedback loop 914 may serve to efficiently and rapidly progress a collective gift to purchase completion. The gain of the feedback loop 914 may be controlled as described above to social media interactions. In a further example, the feedback loop gain may be varied by limiting gift givers who have already purchased a gift portion from purchasing another gift portion, until all potential gift givers have had an appropriate time to consider a purchase of the collective gift for the significant event. The appropriate time may be set to a few days or a few weeks depending on the significant event and the timetable for progression towards it. After the appropriate time the limitation or restriction to the already purchased gift givers may be removed so that multiple portions may be purchased by a gift giver. Additional social media and email notices from the gift receiver, gift provider or an administrator of the collective gift invention may be sent to the feedback pool of gift givers 1014 regarding the removal of the purchasing restriction. Feedback loop gain may also be varied and/or controlled by varying a number of repeat purchases that may be made by each gift giver. In addition varying or controlling the allowed time between each gift portion purchase may also vary the feedback loop gain.

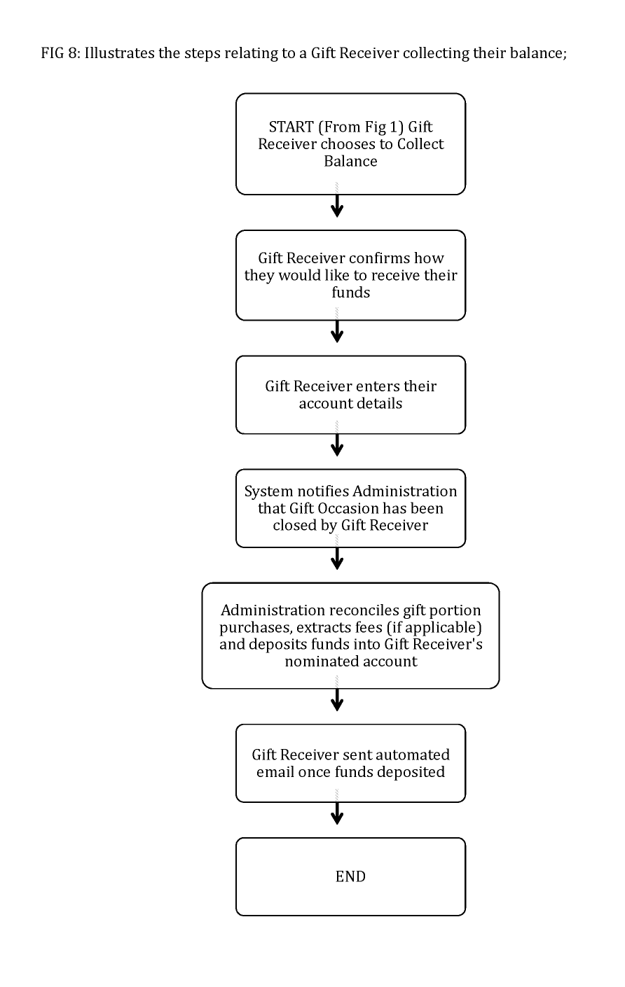

FIG. 8 is a flow chart to a process that may be followed once all the gift portions for a significant event have been purchased or at least a sufficient number of gift portions have been purchased by gift givers. Alternatively, as described above, another process (not shown) may be followed where once a sufficient number of gift portions or all gift portions are purchased then the manufacturer, supplier, service provider or third party retailer may be notified by the invention to supply the gift to the gift recipient. It will be readily appreciated that further interactions with social media may be included in FIG. 8 to provide notices to the gift givers that the gift has been received by the gift recipient. In addition the gift givers may receive further feedback from the gift recipient and the gift provider regarding the significant event. The further feedback may include experiences with the gift and acknowledgement and gratitude to the gift givers for the gift. The notices and further feedback may be timed with or otherwise triggered according to the date of the significant event. Such further positive feedback may serve to encourage gift givers considering their own significant event/gift occasion to use the invention.

In this specification, terms denoting direction, such as vertical, up, down, left, right etc. or rotation, should be taken to refer to the directions or rotations relative to the corresponding drawing rather than to absolute directions or rotations unless the context require otherwise.

Although the invention has been herein shown and described in what is conceived to be the most practical and preferred embodiments, it is recognised that departures can be made within the scope of the invention, which are not to be limited to the details described herein but are to be accorded the full scope of the appended claims so as to embrace any and all equivalent assemblies, uses, applications, pictorial representations and assemblies, devices and apparatus.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise, comprised and comprises” where they appear.

It will further be understood that any reference herein to known prior art does not, unless the contrary indication appears, constitute an admission that such prior art is commonly known by those skilled in the art to which the invention relates.

1. A method for gifting collectively comprising:
providing a gift for a significant event;
dividing the gift into at least two gift portions;
notifying at least two gift givers to the significant event, wherein each gift giver selects one or more gift portions associated with the significant event;
purchasing of each selected gift portion by each selecting gift giver; and
repeating the previous two steps until substantially all the gift portions are purchased, and providing the gift to a gift recipient, thereby the gift givers collectively gift to the gift recipient.

2. A method according to claim 1, further comprising:
communicating to a pool of gift givers the purchase of each selected gift portion.

3. A method according to claim 2, further comprising:
varying a feedback loop gain by varying at least one of a social media sharing or interaction, a number of repeat purchases of gift portions by each gift giver and the time between each gift portion purchased.

4. A method according to claim 2, further comprising:
communicating to the pool of gift givers of the purchase of gift portions prior to the purchase of all the gift portions.

5. A method according to claim 1, further comprising:
representing the gift as a gift image; and
dividing the gift image into the gift portions.

6. A method according to claim 5, further comprising:
displaying or indicating the purchased gift portions with or on the gift image.

7. A method according to claim 5, further comprising:
assigning at least one gift portion to at least one component of the gift represented by the gift image.

8. A method according to claim 5, wherein:
the dividing the gift into gift portions includes creating at least one symbolic gift portion and assigning the symbolic gift portion to a corresponding component of the gift represented by the gift image.

9. A method of collectively revealing a gift image comprising:
providing a gift image;
creating a selectively removable overlay, the overlay having at least two selectively removable segments, each segment being superimposed on a portion of the gift image;
providing a pool of gift givers; and
enabling at least one gift giver to selectively remove one or more of the selectively removable segments of the overlay;
whereby the gift image is progressively revealed.

10. A method according to claim 9, further comprising:
assigning each segment a monetary value.

11. A method according to claim 10, further comprising:
enabling the at least one gift giver to participate in selectively removing the segment upon payment of the monetary value for the segment.

12. A method according to claim 9, further comprising:
selectively removing segments and displaying the gift image with a graphical user interface.

13. A method according to claim 9, further comprising:
assigning at least one segment to at least one corresponding component of a gift represented by the gift image.

14. A method according to claim 9, wherein:
the creating the overlay includes creating a symbolic overlay and assigning at least one symbolic segment to a corresponding component of a gift represented by the gift image.

15. A method according to claim 9, further comprising:
communicating to the pool of gift givers the selective removal of a segment.

16. A graphical user interface for a gift collective system comprising:
a gift dividing user interface component for use by at least one of a gift provider and a gift recipient, wherein the gift dividing user interface component is configured to divide a gift into two or more gift portions and display the gift portions to at least two gift givers;
a selecting user interface component configured to select one or more gift portions by each gift giver and indicate the selected gift portions; and
a processor configured to provide at least one of: the gift dividing user interface component and the selecting user interface component.

17. A graphical user interface according to claim 16, wherein:
the gift dividing user interface component includes a pattern overlay to a gift image of the gift and the pattern overlay delineates the gift portions.

18. A graphical user interface according to claim 16, wherein:
the gift dividing user interface component allows for selecting components of the gift to form the gift portions.

19. A gift collective system comprising:
an interface means for a gift recipient or a gift provider to select a gift;
a gift dividing means for dividing the gift into at least two gift portions;
a graphical user interface means displaying the gift portions to at least two gift givers;
a processor; and
a memory means for registering a status of the gift portions;
wherein the processor is configured to perform at least one of: the interface means and the gift dividing means;
wherein the graphical user interface means interacts with each gift giver so that each gift giver can select and purchase at least one gift portion and the graphical user interface means interacts with the memory means to the status of a purchased gift portion; and
whereby a purchase of substantially all of the gift portions by the gift givers provides the gift to the gift recipient.

20. A gift collective system according to claim 19, further comprising:
a means for representing the gift as a gift image;
wherein the gift dividing means divides the gift image into the gift portions.

21. A gift collective system according to claim 19, wherein:
the processor is configured to perform at least one of: the graphical user interface means and a monitoring means for a total of the purchased gift portions.

22. A gift collective system according to claim 19, wherein:
the processor is configured to communicate one or more gift portions statuses to a group of gift givers.

23-25. (canceled)
